(19) United States
(12) Patent Application Publication
(10) Pub. No.: US 2011/0065381 A1
(43) Pub. Date: Mar. 17, 2011

(54) METHOD OF TRANSMITTING HIGHER POWER FROM A SATELLITE BY MORE EFFICIENTLY USING THE EXISTING SATELLITE POWER AMPLIFIERS

(76) Inventor: Howard Hausman, Hauppauge, NY (US)

(21) Appl. No.: 12/883,141

(22) Filed: Sep. 15, 2010

Related U.S. Application Data
(60) Provisional application No. 61/242,669, filed on Sep. 15, 2009.

(51) Int. Cl. H04B 7/185

(52) U.S. Cl. 455/12.1

(57) ABSTRACT

A method of enhancing the power transmitted from a satellite includes the steps of modulating a carrier signal at an Earth station. The non-linearity is established of a downlink amplifier on the satellite. The modulated carrier signal is to compensate for the non-linearity of the downlink and/or the uplink amplifiers. The predistorted modulated carrier signal is transmitted in an uplink to the satellite. The uplink carrier is amplified in the downlink amplifier. A downlink signal is to an Earth station, whereby the downlink signal compensates for non-linearities in the downlink amplifier to thereby optimize amplification with minimum distortion of the signals. A system for implementing the method is described.

### CROSS-REFERENCE TO RELATED APPLICATION

This Application corresponds to U.S. Provisional Patent Application Ser. No. 61/242,669 filed Sep. 15, 2009.

### BACKGROUND OF THE INVENTION

1. Field of the Invention

The invention generally relates to Satellite Communication Systems and, more specifically to a method of transmitting higher power from a satellite by more efficiently using the existing satellite power amplifiers.

2. Description of the Prior Art

Satellite systems are sometimes limited in the amount of power that they can transmit before meaningful signal distortion takes place. Once the distortion is excessive, due to saturation of the satellite amplifier(s), the amount of power that can be transmitted by the saturated satellite may be significantly reduced. Thus, while it is normally desired to maximize the output power transmitted by the satellite, the transmission back to Earth is preferably not so distorted that important data may be lost. However, simply increasing the magnitude or level of the uplink signal in order to increase or maximize the power in the downlink signal does not always achieve the desired result since, as suggested, distortions may became significant when the uplink signal amplitudes are made too high for the amplifiers in the satellite.

### SUMMARY OF THE INVENTION

Accordingly, it is an object of the invention to provide system of transmitting higher power from a satellite by more efficiently using the existing satellite power amplifiers.

It is another object of the invention to provide a method or technique for using the system of the previous object.

It is still another object of the invention as in the previous objects to provide a technique and system for implementing the same that allows higher power to be received on Earth while using simpler and more mobile equipment in a satellite.

It is yet another object of the invention to provide a system and technique as in the aforementioned objects which provide accurate results.

It is an additional object of the invention to provide a method system as aforementioned that is simple and less costly to use while providing accurate results.

### BRIEF DESCRIPTION OF THE DRAWINGS

The above and other objects, features and advantages of the present invention will be better understood from the following specification when read in conjunction with the accompanying drawings.

FIG. 1 is a block diagram illustrating a system for implementing a technique or method of transmitting higher power from a satellite; and

FIG. 2 is a flow chart illustrating the steps in using the systems shown in FIG. 1.

### DETAILED DESCRIPTION OF A PREFERRED EMBODIMENT

Referring to the Figure, a system and technique are illustrated for using pre-distortion to correct for non-linearity in satellite high power amplifiers.

The system for enhancing the output from a satellite in accordance with the present invention is generally designated by the reference numeral 10.

The system 10 includes a solid state pre-amplifier 12, an input of which is provided with a modulated signal S. The output of the pre-amplifier 12 is applied to the input of a linearized circuit 13 that includes a pre-distortion linearizer 14. The output of the pre-distortion linearizer is applied to a traveling wave tube amplifier (TWTA) 16. The amplifier 16 can be operated in the linear or the non-linear mode with the pre-distortion linearizer 14 correcting the power amplifier on earth and in the satellite. In addition the power amplifier 16 can be a Solid State Power Amplifier (SSPA) or any other suitable power amplifier.

Predistortion is a technique used to improve the linearity of radio transmitter amplifiers.

Radio transmitter amplifiers in most telecommunications systems are required to be “linear”, in that they must accurately reproduce the signal present at their input. An amplifier that compresses its input or has a non-linear input/output relationship causes the output signal to splatter onto adjacent radio frequencies. This causes interference on other radio channels.

The predistortion circuit inversely models the amplifier's gain and phase characteristics and, when combined with the amplifier, produces an overall system that is more linear and reduces the amplifier's distortion. In essence, “inverse distortion” is introduced into the input of the amplifier, thereby cancelling any non-linearity the amplifier might have.

Predistortion is a cost-saving technique. Radio power amplifiers tend to become more non-linear as their power increases towards their maximum rated output. J Predistortion is a way to get more usable power from the amplifier, without having to build a larger and more expensive amplifier.

Optimization of the power output and linearity are generally not compatible. Frequently, linearity is achieved either by reducing efficiency or by using linearization techniques. However, most linearization methods are limited in the maximum correctable range, which is the region of power output level on the onset of saturation. For the pre-distortion linearizer 14, the specific method or scheme for pre-distorting within the linearizer 14 is not critical for purposes of the present invention, and any suitable pre-distortion linearizer 14 can be used with different degrees of advantage. One example of a pre-distortion method is disclosed in U.S. Pat. No. 5,903,611. A pre-distortion linear transmittal is also disclosed in U.S. Pat. No. 6,411,390. Both of these patents are incorporated as if fully set forth herein. See, also, “Linearizing Power Amplifiers Using Digital Predistortion, EDA Tools and Test Hardware” by Mekechuk et al., High Frequency Electronics, April 2004. As indicated, the specific method used for pre-distorting the signal is not critical as long as it provides an inverse modeling scheme to more easily and accurately determine the inverse of the distortion caused by the power amplifiers in the satellite.

The pre-distortion linearizer 14 is adjusted to effectively modify the transfer function to distort the input that it receives to substantially compliment the transmittal function of the satellite power amplifier so that once the signal is amplified and distorted at higher power outputs by the satellite power amplifiers, the signals are retransmitted to the Earth, in effect, are compensated to provide a substantially non-distorted or minimally distorted signal despite the non-linearity in the satellite amplifiers. In practice, the linear TWTA 16 may also introduce some non-linearity and the predistortion linearizer 14 may also compensate for that non-linearity or for the total effective downstream non-linearity.

Satellite power amplifiers can transmit higher powers if the Earth Station signal is pre-distorted to compensate for the satellite non-linearity. The invention uses existing satellite non-linearity data or measured non-linearity of the satellite to pre-distort the transmitted signal on Earth before transmission of such signal returning to Earth so that it is linear even though the satellite high power amplifier is operating in a non-linear mode.

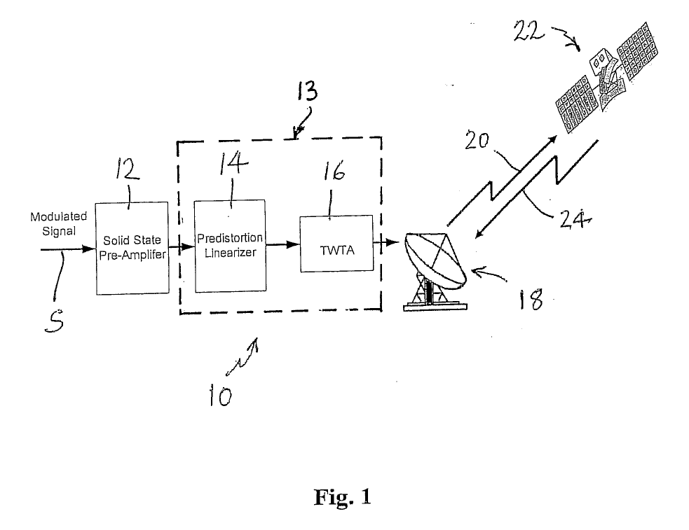

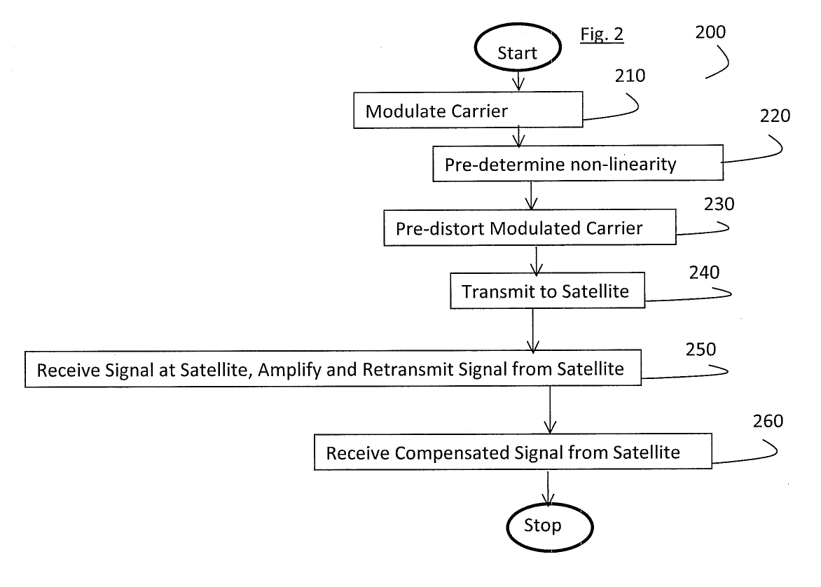

Referring to FIG. 2, a flow chart illustrates the steps in using the system of FIG. 1 in implementing the method for more efficiently using existing satellite power amplifiers. The method (200) is initiated by modulating (210) a carrier signal S. The nonlinearity in the system, in particular in the downlink amplifiers in the orbiting satellite (22) are determined (220). The nonlinearity can be determined from prior measurements while the amplifiers were on the ground and prior to sending the satellite into orbit or by utilizing various techniques in determining the nonlinearity or the transfer function of the downlink amplifiers, such as by using a technique described in co-pending U.S. patent application Ser. No. ______ filed Sep. 15, 2010 by the Assignee of the subject Application and that corresponds to Provisional Application Ser. No. 61/242,657 filed on Sep. 15, 2009. Once the properties or characteristics of the nonlinearity are known the modulated carrier is pre-distorted (230) by using a pre-distortion linearizer (14). After the amplified in the linear TWTA (16) the pre-distorted signal is transmitted (240) to the satellite (22) in uplink signal (20) and retransmitted (250) from the satellite. Since the pre-distortion effectively compliments the transfer function parameters or properties of the downlink amplifiers in the satellite, and potentially also any nonlinearities introduced by the TWTA (16), the downlink signal (24) that is received (260) is a compensated signal from the satellite which is free or substantially free of distortions.

The advantage of this technique is that higher power signals can be sent from the satellite to earth. Higher power allows the user on Earth to receive the signal using smaller, simpler and more mobile equipment.

The foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

1. A method of enhancing the power transmitted from a satellite comprising the steps of:
modulating a carrier signal at an Earth station;
establishing the non-linearity of a downlink amplifier on the satellite;
predistorting the modulated carrier signal to compensate for the non-linearity of the downlink amplifier;
transmitting the predistorted modulated carrier signal in an uplink to the satellite;
amplifying the uplink carrier in said downlink amplifier; and
transmitting a downlink signal to an Earth station, whereby said downlink signal compensates for non-linearities in said downlink amplifier to thereby optimize amplification with minimum distortion.

2. A method as defined in claim 1, wherein said step of predistorting comprises the steps of predistorting linearization and linear amplification of said modulated signal.

3. System of enhancing the power transmitted from a satellite comprising a modulator for modulating a carrier signal at an Earth station;
a linearized amplifier for predistorting the modulated carrier signal to compensate for a non-linearity of a downlink amplifier on a satellite;
a transmitter for transmitting the modulated carrier signal to a satellite having a downlink amplifier with inherent non-linearity, said linearized amplifier predistorting said modulated signal to compensate for said inherent non-linearity whereby downlink signals received at the Earth station can be optimized while exhibiting minimum distortion.

4. System as in claim 3, wherein said linearized amplifier comprises a predistortion linearizer and a traveling wave tube amplifier (TWTA).
